(19) United States
(12) Patent Application Publication
(10) Pub. No.: US 2005/0262427 A1
(43) Pub. Date: Nov. 24, 2005

(54) System and method for managing website content

(75) Inventors: Brad A. Cantwell, League City, TX (US); Clifton E. Grim III, Seabrook, TX (US); Rex E. Marzke, Houston, TX (US); Andrew P. McDowell, Friendswood, TX (US)

Correspondence Address: HOFFMAN WARNICK & D'ALESSANDRO, LLC, 75 STATE STREET, 14TH FL, ALBANY, NY, 12207, US

(73) Assignee: International Business Machines Corporation, Armonk, NY (US)

(21) Appl. No.: 10/403,666

(22) Filed: Mar. 31, 2003

(51) Int. Cl. G06F 17/00

(52) U.S. Cl. 715/501.1

(57) ABSTRACT

A system and method for mapping between live web pages and source content to manage website content. A content administration system is disclosed for managing content areas within a set of web pages, comprising: an administrative interface for viewing and navigating the set of web pages in a live environment, wherein the administrative interface causes an edit link to be displayed for each live content area within the web pages; and a source content management tool for managing source content for the set of web pages, wherein in response to a user clicking on an edit link for a selected live content area, the source content management tool is automatically launched and loaded with the source content for the selected live content area.

### BACKGROUND OF THE INVENTION

1. Technical Field

The present invention relates generally to managing World Wide Web (“web”) content, and more particularly relates to a system and method for mapping or linking between live web pages and an administration tool to manage the content.

2. Related Art

As the popularity and importance of the World Wide Web (“web”) have grown, the demand for tools that can effectively manage websites has also grown. One particular area involves managing live or dynamic content, e.g., content that includes links to other resources. Depending on the complexity and size of the website, a large number of hierarchically related web pages may be utilized. The result is often a complex dynamic content infrastructure that requires ongoing maintenance to ensure the accuracy and freshness of the live content.

Web portals, which provide anchor websites through which users can access various types of live content, typify situations in which the above-mention challenges arise. A typical web portal may include many content areas buried within any number of portal pages that provide numerous live links to various resources, such as directories of websites, a facility to search for other sites, news, weather information, e-mail, stock quotes, phone and map information, a community forum, etc. Given the number of potential links within a web portal, a need exists for a system and method that can effectively manage all of the live content.

As is known in the art, web pages are made up of web source content that must be managed (i.e., created, edited and stored) using some type of editing tool. Existing tools generally do not allow an editor to navigate and edit web pages as though they are viewing the web pages in a browser. Rather, because web source content is written in a mark-up language format such as hypertext markup language (HTML), a special administrative tool is required to mange/edit the web source content (“source content”). Consequently, managing live content web pages can be a tedious operation, and simple tasks, such as identifying the source content for a particular web page content area can consume significant time and resources.

Such tasks are further complicated by the fact that the web source content for a website is typically managed from an administrative server that is separate from the server that serves the actual live web pages. Because of this dichotomy between the source content and the live web pages, there exists no straightforward manner for mapping between live web page content areas and the associated source content used to construct the content areas.

Accordingly, a need exists for a system and method that will allow content administrative users to easily map between web page presentations and the associated web source content.

### SUMMARY OF THE INVENTION

The present invention addresses the above-mentioned problems, as well as others by providing a system and method for mapping between web page presentations and the administrative tools for managing the associated source content. In a first aspect, the invention provides a content administration system for managing content areas within a set of web pages, comprising: an administrative interface for viewing and navigating the set of web pages in a live environment, wherein the administrative interface causes an edit link to be displayed for each live content area within the set of web pages; and a source content management tool for managing source content for the set of web pages, wherein in response to a user clicking on an edit link for a selected live content area, the source content management tool is automatically launched and loaded with the source content for the selected live content area.

In a second aspect, the invention provides a program product stored on a recordable medium for managing content areas within a set of web pages, the program product comprising: an interface for viewing and navigating the set of web pages in a live environment; an administrative mode that causes the interface to display edit links within the web pages for a set of predetermined content areas; and a mapping system that launches a source content management tool in response to a user clicking on the edit link for a selected content area, wherein the mapping system further causes the source content management tool to automatically load the source content for the selected content area.

In a third aspect, the invention provides a method for managing content areas within a set of web pages, comprising the steps of: instigating an administrative interface for viewing and navigating the set of web pages in a live environment, wherein the administrative interface causes edit links to be displayed within the set of web pages for each content area; clicking on one of the edit links for a selected content area; and launching a source content management tool and loading the source content management tool with the associated source content for the selected content area.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a content administration system in accordance with the present invention.

FIG. 2 depicts a screen shot of a web page including viewable edit links in accordance with the present invention.

FIG. 3 depicts a screen shot of an administrative tool for managing the content of the web page of FIG. 2.

FIG. 4 depicts a flow diagram of the operation of an administration tool for managing web content in accordance with the present invention.

### DETAILED DESCRIPTION OF THE INVENTION

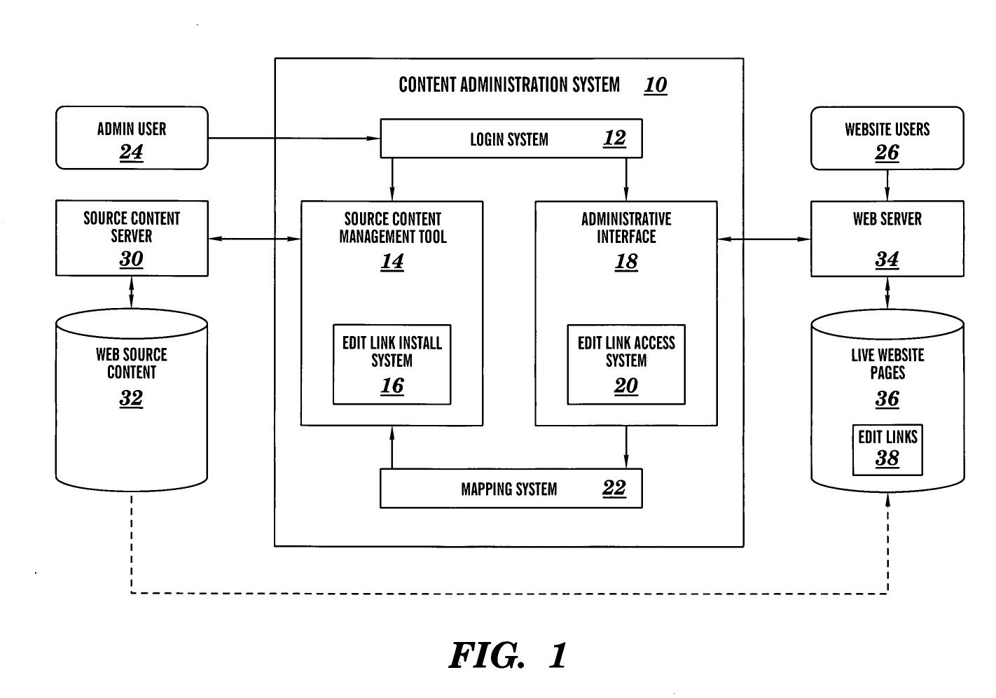

Referring now to the drawings, FIG. 1 depicts a content administration system 10 for managing web source content 32 that can be presented as live website pages 36 via web server 34 to website users 26. The content administrative system 10 includes a login system 12 that provides access for an administrative user 24, e.g., by entering a login name and password on a web page on the web or local area network. Once the administrative user 24 logs in, the user has access to both a source content management tool 14 and an administrative interface 18. Source content management tool 14 may provide some or all of the traditional features of prior art content administration tools, e.g., the ability to create, replace, view, edit, delete, and store web source content 32 via a source content server 30.

Administrative interface 18 allows the administrative user 24 the ability to view the live website pages 36 in a special administrative mode via web server 34. When in administrative mode, mapping system 22 provides a mechanism that allows the administrative user 24 to map between the web source content 32 and live website pages 36 in a manner described below.

Initially, when a web page is created, for instance by source content management tool 14, a special link is placed into the HTML source. These special links, referred to herein as “edit links” may be installed manually by the administrative user 24, or automatically by the edit link install system 16. Each edit link includes a set of HTML statements that causes the source content management tool 14 to be launched (i.e., causes the browser to be directed to the tool's address) and causes the web source content 32 associated with the live content area to be loaded and displayed within the source content management tool 14. An example of an HTML edit link statement is as follows:
<a
href=“http://az.gov/webapp/admin/DocumentTreeAdminServlet?showcontentpreview=true&treename=DocumentTree&rootname=DocumentRoot&parentid=2785&nodeid=2789&done=DocumentTreeAdminServlet%3Fshowfoldercontents%3Dtrue%26treename%3DDocumentTree%26rootname%3DDocumentRoot%26parentid%3D2785”>[EDIT]</a>

In this example, the [Edit] link string can be seen associated with an HTML reference to the URL of the source content management tool 14. Thus, by clicking on the edit link within a live web page, the user's browser is directed from the live web page to the source content management tool 14, loaded with the source content for the web page.

Accordingly, whenever web source content is uploaded from the source content server 30 to web server 34, each of the live website pages 36 may include an edit link 38. The edit links 38 are installed in a manner such that they can only be viewed and accessed by an administrative user 24 when in the special administrative mode, i.e., via the administrative interface 18. Specifically, administrative interface 18 includes an edit link access system 20 that causes any edit links to appear on the particular live web pages being viewed. Edit link access system 20 may be implemented using “cookies.” For example, when the administrative user 24 logs onto the content administration tool 10, a cookie is written with key information identifying the user as an administrative user 24. When an HTML page is rendered out by the web server 34, the edit links 38 are activated by the web server and are viewable if the user's cookie has the correct key information. It is understood that other mechanisms could be implemented to achieve the same functionality, such as URL rewriting with Session ID's in the URL.

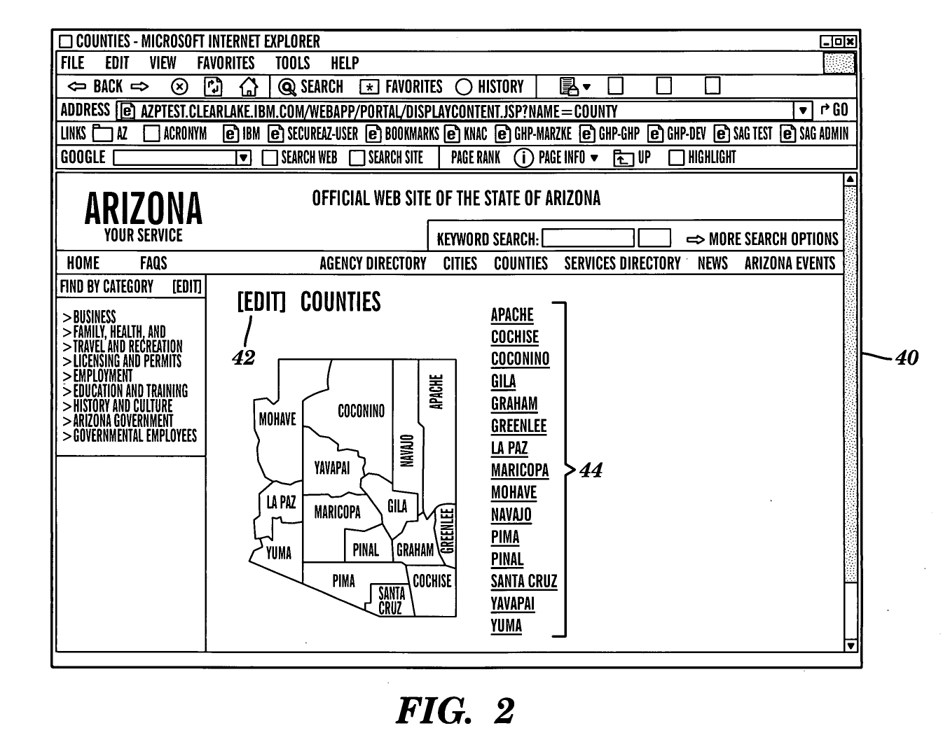

An exemplary live web page 40 viewed within administrative interface 18 is shown in FIG. 2. Web page 40 includes a list of counties in Arizona and may, for instance, be “linked to” from the State of Arizona portal page (not shown). In this example, it is assumed that the web page 40 is served locally as one of the live web site pages 36 accessible via web server 34. When viewed in this administrative mode, web page 40 includes an edit link 42 that appears as a hypertext link “[EDIT]” next to the word “Counties.” The edit link 42 is associated with the live content area 44 that appears on this page, i.e., the list of counties, etc. Obviously, indicia other than [EDIT] could be used to identify an edit link to the administrative user 24.

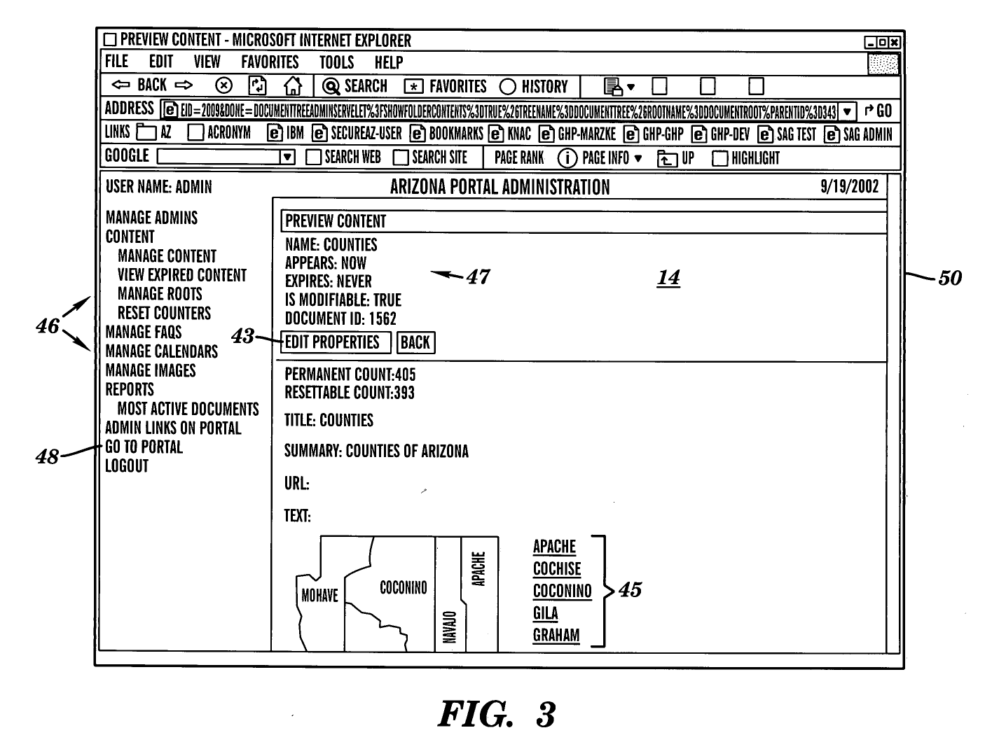

Accordingly, if the administrative user 24 were to click on edit link 42, the browser would launch the source content management tool 14 (i.e., point the browser at a predetermined URL). An exemplary screen shot 50 of this is shown in FIG. 3. As can be seen, the web source content 45 and properties 47 associated with live content area 44 are displayed within the source content management tool 14. From here, the administrative user 24 can edit or otherwise manage the source content 45 and properties 47 using the various management facilities 43, 46. When finished, the administrative user 24 can view the changes to the live web page 40 by clicking on the “go to portal” link 48. Thus, by using edit links as described above, mapping system 22 allows the administrative user to easily navigate between live web site pages 36, 40 and web source content 32, 45.

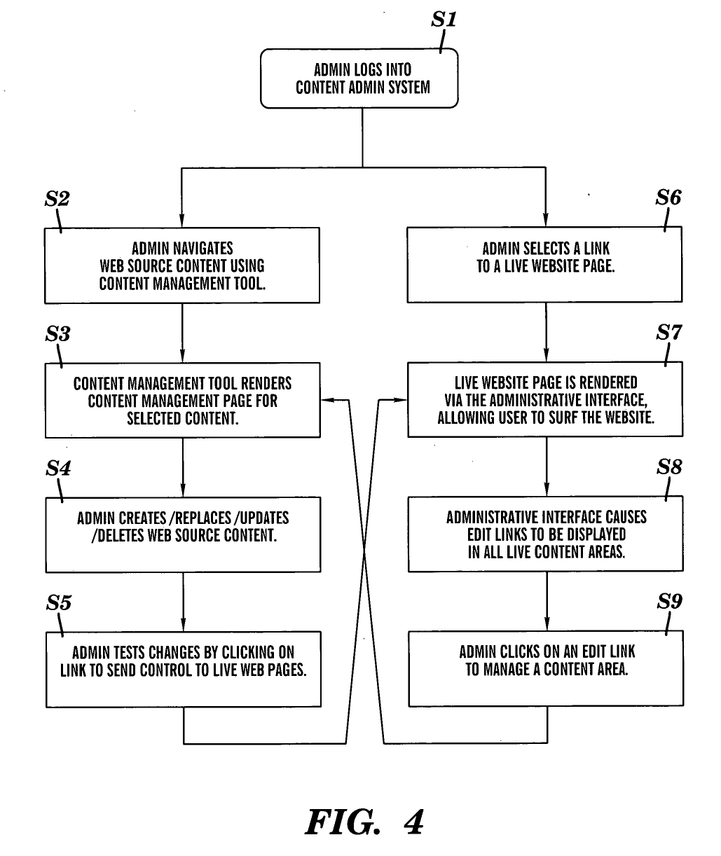

Referring now to FIG. 4, a flow diagram is depicted that describes an exemplary methodology of using the content administration system 10 to manage a targeted web content area. First, in step S1, the administrative user logs into the content administration system 10. This may be done, for instance, using a browser pointed at a login screen web page at a predefined address on the web or local area network. Next, the administrative user 24 has the choice of using the content management tool 14 (step S2) or selecting a link to a live web page (step S6).

If the content management tool 14 is used (step S2), the administrative user 24 navigates the web source content using the tool 14 until the targeted web content area is identified. The use of such a tool in this manner is common in known content administration tools. Once identified, the content management tool 14 renders the source content on the content management page (e.g., as shown in FIG. 3) for the selected content area (step S3). Next, the administrative user 24 performs the necessary management task, e.g., create, replace, update, and/or delete, on the selected content area (step S4). Next (step S5), the administrative user can test any changes by clicking on a link that will send control to an administrative interface to view the live web page (step S7).

As a second option, rather than using the traditional management methodology described above, the administrative user 24, operating in an administrative mode, can select a link to a live website page after logging in (step S6). In an exemplary embodiment, the live website page may refer to the anchor page for a web portal. However, it is understood that the link to the live website page may refer to any entry point within a website. Next at step S7, a live web page (associated with the link to the live website) is rendered via the administrative interface 18. The administrative user 24 can then surf the live pages of the website, as though they were a typical end user, in order to find the target content area that requires editing/management. As described above with reference to FIG. 1 and further shown in FIG. 2, the administrative interface causes edit links to be displayed in predefined live content areas (step S8). The administrative user can click on one of the edit links associated with a target content area that the user wants to manage (step S9). This action then sends control to and launches the content management tool 14, which renders the content management page for the target content area (step S3). Thus, by viewing the live web pages in administrative mode, the user can view and click on edit links to navigate from the live web pages to the associated content area within a content management tool.

It is understood that the systems, functions, mechanisms, methods, and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention has been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. A content administration system for managing content areas within a set of web pages, comprising:
an administrative interface for viewing and navigating the set of web pages in a live environment, wherein the administrative interface causes an edit link to be displayed for each live content area within the set of web pages; and
a source content management tool for managing source content for the set of web pages, wherein in response to a user clicking on an edit link for a selected live content area, the source content management tool is automatically launched and loaded with the source content for the selected live content area.

2. The content administration system of claim 1, wherein the administrative interface is instigated after a user logs into the content administration system.

3. The content administration system of claim 2, where the administrative interface comprises a browser having a cookie that allows access to edit links.

4. The content administration system of claim 1, wherein the source content management tool includes a mechanism for launching the administrative interface to view the web pages in a live environment.

5. The content administration system of claim 1, wherein the source content management tool includes a mechanism for installing edit links into the source content.

6. The content administration system of claim 1, wherein the source content is stored separately from the live web pages.

7. The content administration system of claim 1, wherein the source content management tool includes mechanisms for creating, editing, and storing source content.

8. A program product stored on a recordable medium for managing content areas within a set of web pages, the program product comprising:
an interface for viewing and navigating the set of web pages in a live environment;
an administrative mode that causes the interface to display edit links within the web pages for a set of predetermined content areas; and
a mapping system that launches a source content management tool in response to a user clicking on the edit link for a selected content area, wherein the mapping system further causes the source content management tool to automatically load the source content for the selected content area.

9. The program product of claim 8, wherein the interface includes a browser.

10. The program product of claim 9, wherein the administrative mode is activated by enabling a cookie within the browser.

11. The program product of claim 8, wherein the edit links include hypertext markup language statements that launch the source content management tool and load the source content.

12. The program product of claim 8, wherein the source content is stored separately from the live web pages.

13. The program product of claim 8, wherein the source content management tool includes mechanisms for creating, editing, replacing, deleting, and storing source content.

14. A method of managing content areas within a set of web pages, comprising the steps of:
instigating an administrative interface for viewing and navigating the set of web pages in a live environment, wherein the administrative interface causes edit links to be displayed within the set of web pages for each content area;
clicking on one of the edit links for a selected content area; and
launching a source content management tool and loading the source content management tool with the associated source content for the selected content area.

15. The method of claim 14, comprising the further step of:
managing the source content by taking an action selected from the group consisting of: editing the source content, deleting the source content, replacing the source content, creating new source content, and storing the source content.

16. The method of claim 15, comprising the further step of:
providing the source content management tool with a mechanism for launching the administrative interface to view changes made to the source content; and
launching the administrative interface.

17. The method of claim 14, wherein the step of instigating the administrative interface includes the steps of:
pointing a browser to a login page;
logging in to the login page; and
setting a cookie in the browser.

18. The method of claim 14, wherein the source content management tool is automatically launched in response to the clicking of the edit link.

19. The method of claim 14, wherein the edit links are not accessible unless the administrative interface is instigated.

20. The method of claim 14, wherein each content area includes at least one live link.
